(19) United States
(12) Patent Application Publication
(10) Pub. No.: US 2011/0133684 A1
(43) Pub. Date: Jun. 9, 2011

(54) Electric Gas Stations Having Range Extension and Grid Balancing

(75) Inventors: Jostein Eikeland, Boca Raton, FL (US); Stein Christiansen, Parkland, FL (US); Christopher Christiansen, Parkland, FL (US)

(73) Assignee: ALEVO, INC., BOCA RATON, FL (US)

(21) Appl. No.: 12/797,019

(22) Filed: Jun. 9, 2010

Related U.S. Application Data
(60) Provisional application No. 61/185,958, filed on Jun. 10, 2009.

(51) Int. Cl. H01M 10/46; H02J 7/00; H02J 3/14

(52) U.S. Cl. 320/101; 320/107; 307/80

(57) ABSTRACT

A system includes a plurality of rechargeable batteries, a housing in form of a storage facility configured to house the plurality of rechargeable batteries, and a bi-directional charger coupled to a power grid at one end and coupled to the plurality of rechargeable batteries at another end, and configured to charge the plurality of rechargeable batteries.

### CROSS-REFERENCE TO RELATED APPLICATIONS

This application claims the benefit of U.S. Provisional Appln. No. 61/185,958, filed Jun. 10, 2009, which is incorporated herein by reference in its entirety for all purposes.

### BACKGROUND

The present disclosure is directed to a grid balancing station, hybrid and battery electric vehicle charge, exchange and service location, and more specifically, to an energy storage network able to transfer and coordinate energy flow from Grid Ancillary Service station (GAS station) batteries, plug in hybrids, electric vehicles and energy storage equipment.

Battery electric and electric plug-in hybrids are developing rapidly in order to reduce the dependence on oil as an energy source. New and strict pollution policies are forcing the development of transportation means that can use renewable energy and reduce the emission of greenhouse gases.

Electric vehicles require an infrastructure designed to quickly charge and increase the vehicles' range while on the road. However, the increased energy demand will amplify the strain on the already overloaded and inefficient energy grid in use today. Furthermore, managing the amount of cars and removable energy storage equipment may be a complex procedure.

Smart-grids and charge-points are costly to deploy and require upgrades at the charge locations. The power lines and amount of vehicles connected limit the amount of energy that can be transferred and also how quickly the batteries can charge.

The grid needs local storage locations and energy banks for regulation up and down. Alternative natural energy sources' main flaw is the lack of storage in peak production periods.

Local storage areas within the grid with available capacity in peak periods are critical to balancing the grid. The ability to store enough power to supply thousand of commercial and residential properties during peak hours is a key aspect in order to maximize current resources and enhance the ability to plan and forecast energy production needs.

### BRIEF SUMMARY

A local network station that can, among other functions, coordinate energy flow and predict future energy usage will significantly improve energy usage and means of production. To that end, systems for charging rechargeable batteries and using the rechargeable batteries for power grid balancing are disclosed. One embodiment is directed to the connection of series of portable batteries to the grid and their ability to provide regulation up or down. Battery packs are stored in a storage facility in the GAS station and are connected to the grid via one or more bi-directional chargers. Batteries are organized in modules and connected through a modular connection and are charged (regulation down) or provide charge back to the grid (regulation up) as needed. At any time, one or more batteries can be removed from or added to the storage. Batteries are used for regulation up or down which can be managed remotely (e.g., by the utility company or the GAS station network). Batteries may be added or removed from the storage even during regulation up or down. Since each module is connected independently to the charger, removing or adding modules will not interfere with the GAS station operations. Each GAS station control center may direct energy flow within each module.

Another embodiment is directed to employing multiple sources of energy to charge the batteries stored in the GAS station. In addition to the power grid, solar panels on the rooftop and/or wind generators may be used to charge the stored batteries.

Another embodiment is directed to the ability of the GAS station to supply power to a predetermined area of the power grid at the time of power outage or as directed by a utility company. The GAS station can independently supply power to the local grid at the time of a power outage.

Another embodiment is directed to the ability of the GAS station to act as a energy sub-station able to control the energy flow from connected vehicles, energy storage equipment and the GAS station network. The GAS station has the ability to use alternate energy sources to charge the batteries, and is configured to supply power to a predetermined area as directed by a utility company. Therefore, the GAS station can act as a sub-station where it supplies power to an area and controls energy flow from multiple sources.

Another embodiment is directed to the ability of the GAS station to charge electric vehicles from stored batteries, which enables charging unrelated to grid connection or power supply availability. The GAS station can use the energy stored it the batteries to supply power to consumers directly from the batteries and without receiving any power from the grid.

Another embodiment is directed to a charge spot adapted to provide charge to vehicles with adjustable voltage. The voltage of the charge spot is adjustable and allows the user to select the voltage level. This is used to rapidly charge a battery in a vehicle without being limited by the amount of voltage from the power grid.

The following detailed description and the accompanying drawings provide a better understanding of the nature and advantages of the present invention.

### BRIEF DESCRIPTION OF THE DRAWINGS

FIG. 1 is a schematic and exemplary Grid Ancillary Service (GAS) station operating as a grid regulation station, service, range and exchange extender;

FIG. 2 is an illustration of the energy flow within the GAS station;

FIG. 3 is a modular illustration of the GAS station;

FIG. 4 is an illustration of a GAS station integrated with the grid;

FIG. 5 is an illustration of a GAS station providing power to the surrounding residential area;

FIG. 6 is a modular illustration of the internal energy systems within the GAS station;

FIG. 7 is a macro illustration of the impact the GAS stations may have on the surrounding area when organized into the grid as energy management substations; and

FIG. 8 is a schematic illustration of the energy flow in the grid utilizing GAS stations as energy management substations.

### DETAILED DESCRIPTION OF THE INVENTION

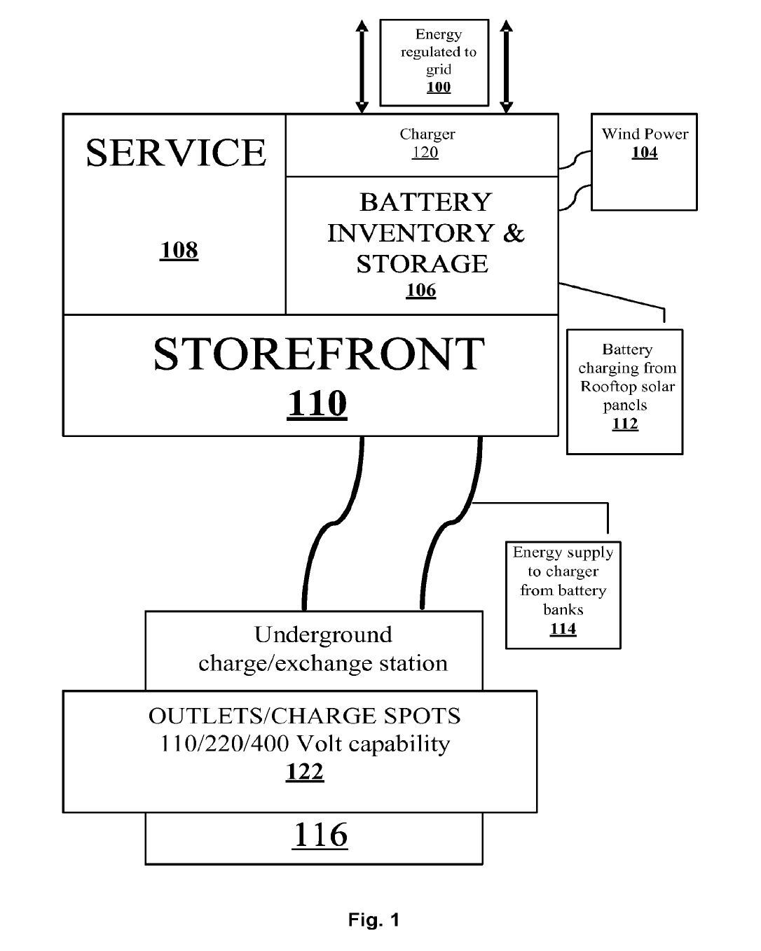

FIG. 1 is an illustration of an exemplary Grid Ancillary Service (GAS) station utilizing battery inventory 106 as energy bank. Batteries inventory 106 may be any type of rechargeable battery, and may be in the form of battery modules each having multiple battery packs. The battery packs may be continuously connected to grid 100 and may be remotely set to provide regulation up or down when needed by governing utility company or GAS station network. The quantity of batteries in battery inventory 106 may be easily increased or decreased by adding or removing battery modules depending on demanded capacity. The GAS station may have a capacity ranging from 1 MW to more than 10 MW. Battery packs in battery inventory 106 may transfer DC energy directly to underground charger 116. Underground charger 116 may have a DC/DC converter. Underground line connection 114 may include very high voltage power lines to ensure that enough energy is transferred to vehicle charge spots 122.

To aid in charging the batteries, the GAS station may use rooftop solar panels 112 and wind generators 104. Grid connection 100 may be, for example, a 1000 volt, 1500 ampere connection depending on the size and capacity of the GAS station. In order for the station to regulate back into the grid, charger 120 may allow bi-directional energy flow. The station may have service bays 108 and storefront 110. Energy purchases may be made either at charge spots 122 or in storefront 110. Each station may aid in service and technical maintenance at the station's service bay 108.

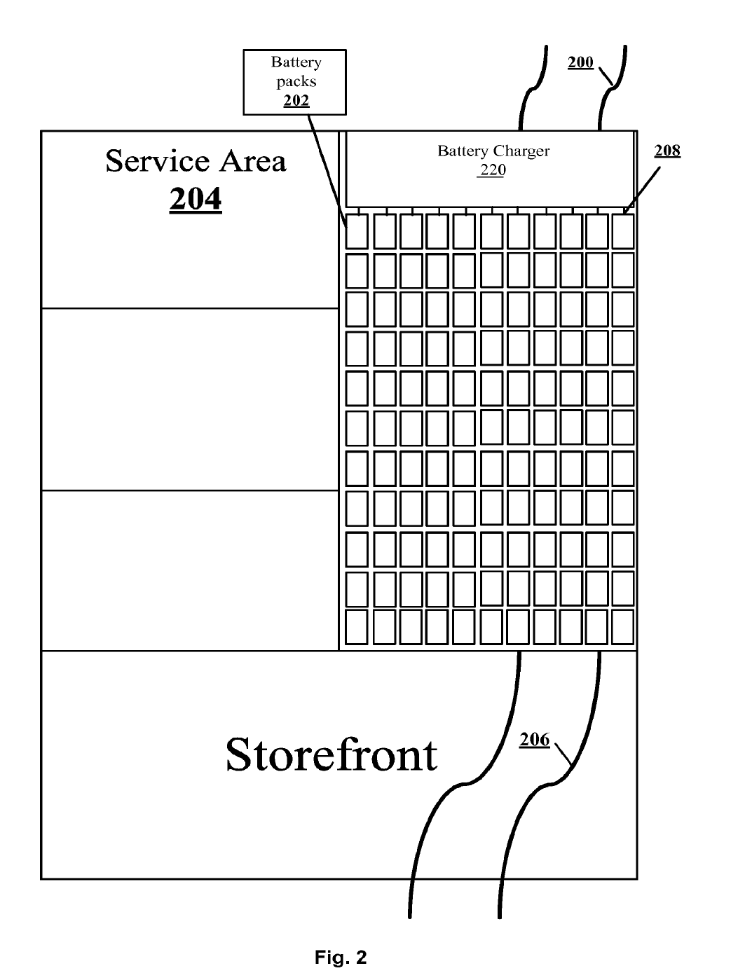

FIG. 2 illustrates the internal energy flow within the GAS station. Battery charger 220 may accept energy flow from grid 200. Charger 220 may transfer voltages and convert energy from AC/DC and DC/AC when supplying the grid. Each battery pack 202 may be organized in modules and connected through modular connections 208. Energy may be transferred to charging station from battery packs 202 utilizing high voltage power lines 206. Each connection may allow bi-directional flow in order to utilize the GAS station's available battery capacity and the capacity of the connected vehicles or devices.

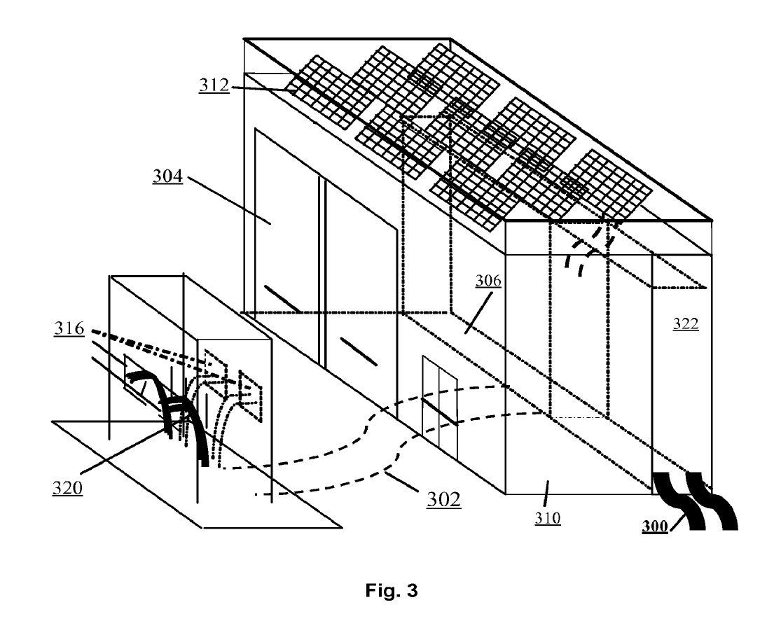

In FIG. 3, charge spots 316 may charge any vehicle's batteries directly from stored DC electricity. Each charge spot 316 may be used individually or in conjunction with several others as each charge spot 316 may have several connections. Vehicles may accept high energy DC power to quickly charge a portion or all of the vehicle's battery packs. The station may be configured to have a battery capacity in excess of 10 MW and a DC charge spot capable of variation of voltages from 110 volts to an excess of 1000 volts with an ampere rating from 20 amperes to an excess of 2500 amperes. Each charge spot 316 may have adjustable voltages at each charge socket. Charge Spots 316 may therefore be capable of charging with very high energy through Super Juicer 320. Super Juicer 320 may be able to provide charge at extremely high energy due to utilizing the station's battery capacity 306 as energy bank and may therefore only be limited by available battery capacity and not grid connection or grid capacity. Super juicer 320 may transfer energy at higher voltages and ampere designated for batteries capable of handling more than 10C to over 100C. Due to its high energy capacity, Super juicer 320 may transfer energy at higher voltages and ampere designated for batteries capable of handling more than 10C to over 100C. Due to its high energy capacity, the super juicer may have a unique connection plug and high voltage connection to station's battery capacity 306. The super juicer may have a unique connection plug and high voltage connection to station's battery capacity 306. The goal of the GAS station may be to rapidly increase a proportion of a vehicle's range rather than complete a full charge.

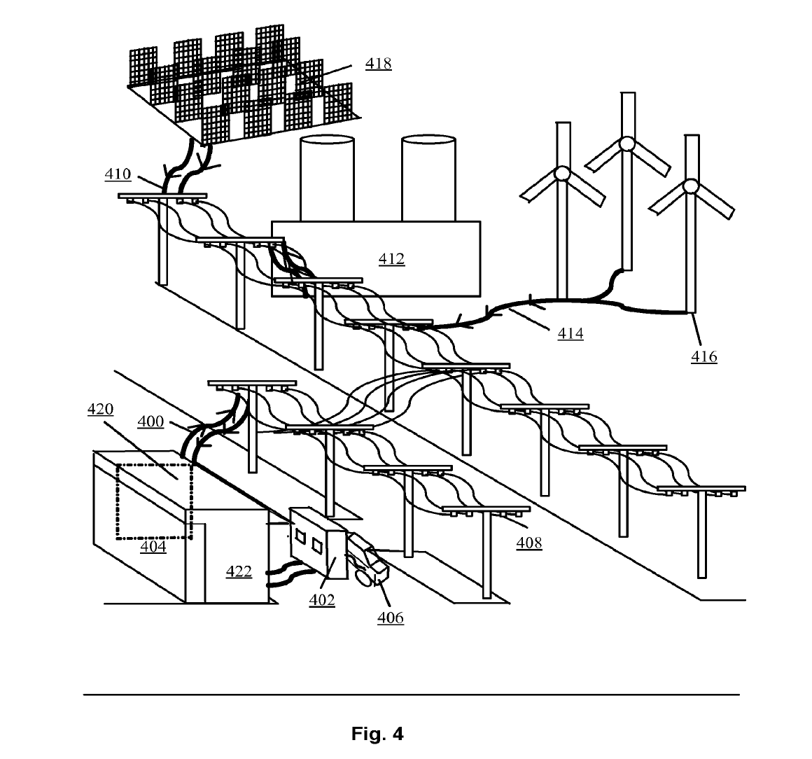

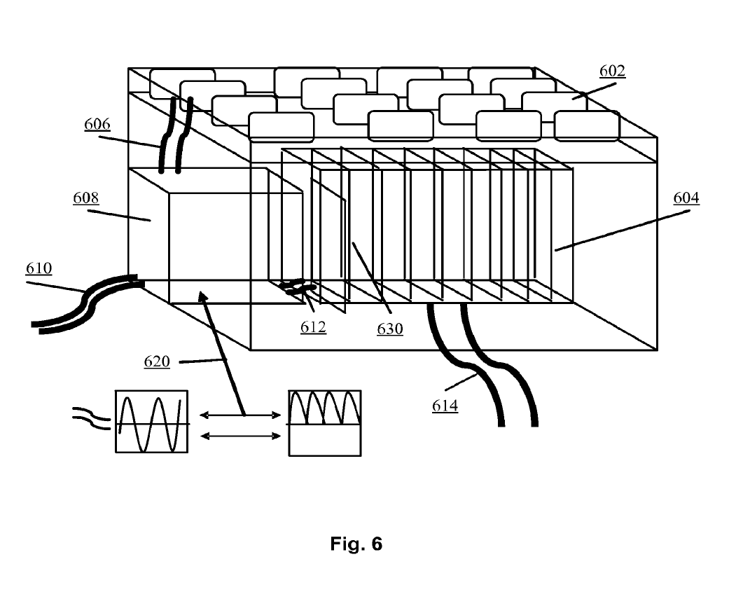

In FIG. 4, charger 420 may charge or discharge energy from or to the grid through grid connection 400 based upon instructions from the governing utility company and communication with GAS station network. GAS stations may be placed in the vicinity of natural energy generators, such as, but not limited to Hydroelectric power plants (not illustrated), wind 416 and solar 418 power generators. FIG. 4 illustrates how a strategic placement of a GAS station may facilitate the use of available capacity of renewable sources. By coordinating the capacity of battery packs 404, utility company 412 can adjust production to maximize the potential from natural sources, such as, but not limited to, solar 418 and wind 416. Utility company 412 may use GAS stations as energy management stations by instructing control center 630 (FIG. 6) to regulate energy based upon energy demand and supply of renewable resources. The object of a GAS station is to provide decentralized energy storage. Each station may provide energy balancing by reducing distance between consumption and generation location. The network of GAS Stations may coordinate energy flow from energy storage equipment and vehicles. Excess energy may be stored at a GAS station for later distribution. A strategic placement may be, in addition to close proximity of renewable energy sources, in areas with a high rate of peaks and wide distribution of electric vehicles. The object of a GAS station may be to provide decentralized energy storage. Each station may provide energy balancing by reducing distance between consumption and generation location. The network of GAS Stations may coordinate energy flow from energy storage equipment and vehicles. Excess energy may be stored at a GAS station for later distribution. A strategic placement may be, in addition to close proximity of renewable energy sources, in areas with high rate of peak usage and wide distribution of electric vehicles. Vehicle 406 may charge from multiple charge points 402 simultaneously and may thereby speed up the charging process.

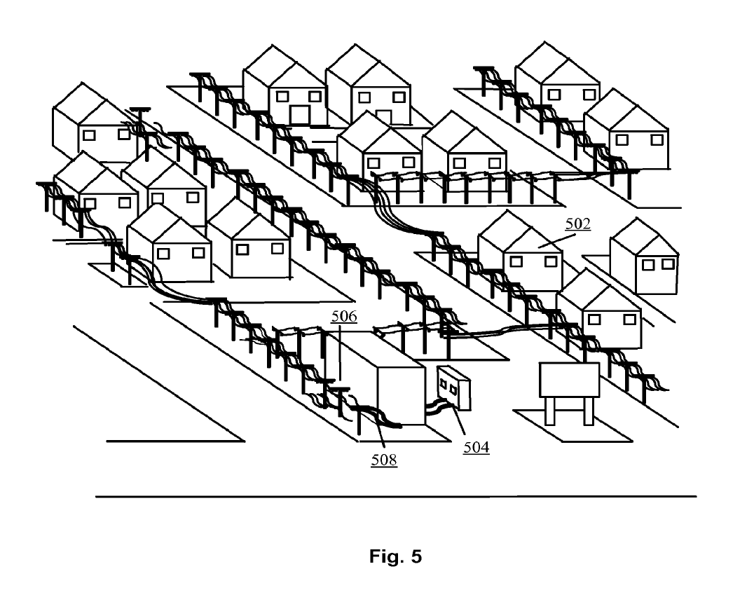

As illustrated in FIG. 5, each GAS station 506 may supply a nearby residential area with several days' worth of energy usage. In case of an energy shortage or downed power line, station 506 may maintain homes 502 with power until the problem is fixed. Depending on the amount of battery modules and grid connection 508, GAS station 506 may supply several hundred homes with power for numerous days.

In FIG. 6, energy grid connection 610 may accept AC energy and convert to DC through a full wave rectifier 620. Each battery module 604 may be rapidly charged to 50-55% of battery capacity. After 55% of battery capacity, battery packs 604 may develop energy sludge in the battery electrolyte as a result of fast charging. In order to complete the charge process, stored sludge energy may be drawn from battery packs 604 and stored into a capacitor (located within charger 608) or battery, or transferred back into the grid. Capacitor (not illustrated) or other energy storage device may redistribute the sludge energy to battery packs 604 or back into the grid. Based upon a low energy connection, battery sludge may not be a factor and regular charging may commence as the electrolyte may remain stable.

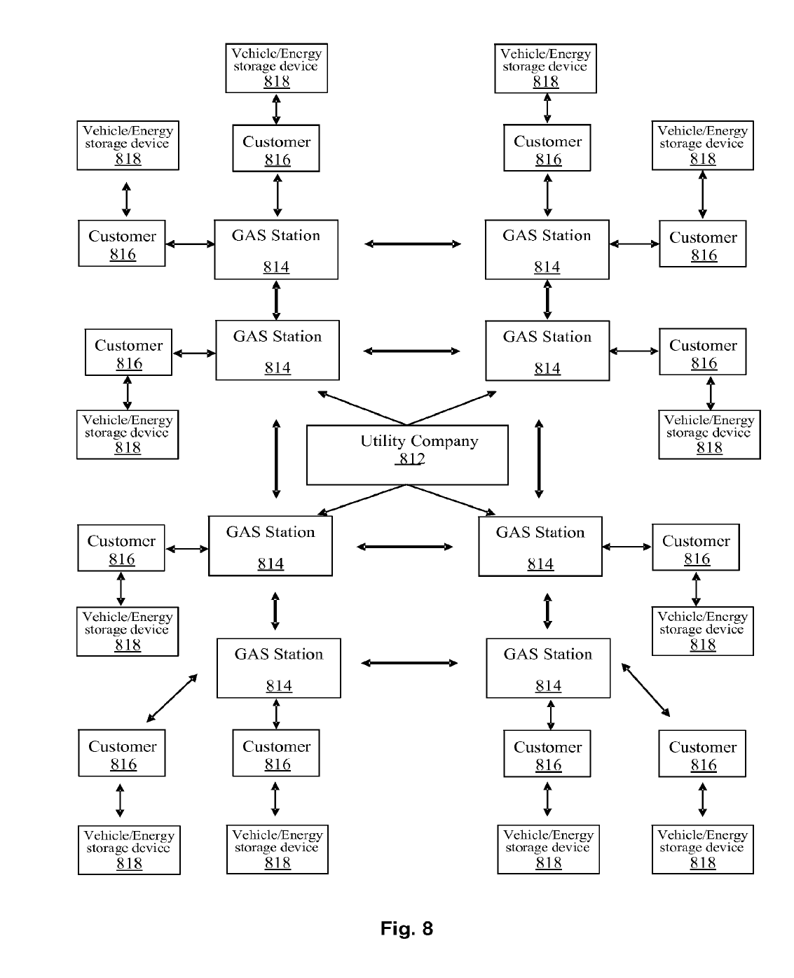

As illustrated in FIG. 6, the GAS station may have a main station control center 630. Control center 630 may receive and transfer information wirelessly or through PLC (power line communication). Control center 630 may communicate through standards such as SCADA (supervisory control and data acquisition), IEEE Synchrophaser C37.118, IEC60870, Zigbee and IEC 61850. Information collected in control center 630 may include available energy, storage capacity and current utilization. GAS stations may be in constant communication with governing utility company and GAS station network. In addition to communicating with the GAS station network, each individual station may function as an energy flow manager for vehicles and other energy storage devices connected in the grid. FIG. 8 illustrates the energy flow within the grid. The flow is initiated by the power generation from utility company 812 to each GAS station 814 connected to the grid. Control center 630 (FIG. 6) may communicate with the utility company and with vehicle/energy storage devices 818 located in the grid. Control Center 630 may read communication from each vehicle/storage device through wireless IP protocols or power line communication, such as binary pulses. In order to manage the flow of energy and develop trends of energy usage, each control center 630 may have scenario management software that may forecast geographical energy usage based upon statistics and social economical trends. Based upon those models, each station 814 may adjust energy storage levels in accordance with projected needs and may be able to remove peak hours by using the GAS station network as a grid balancer.

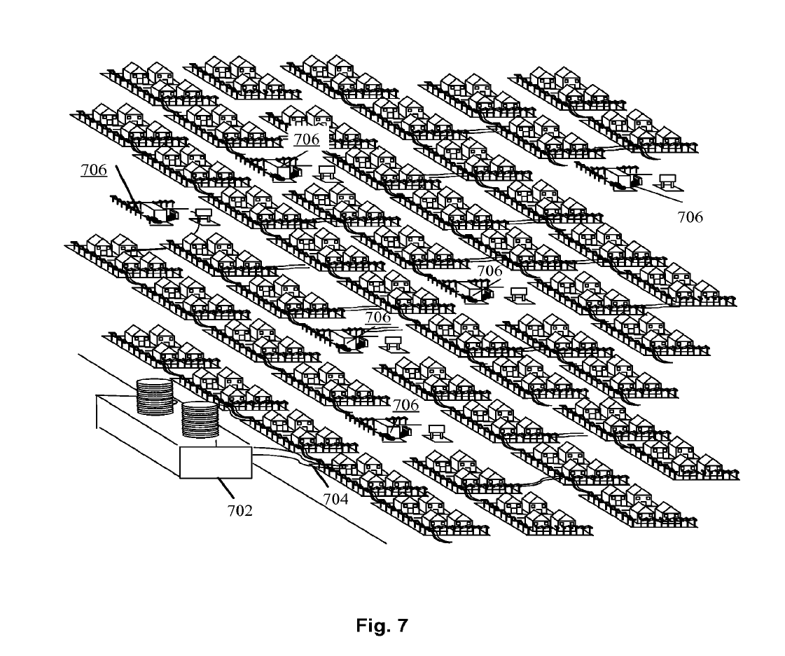

FIG. 7 illustrates how GAS stations 706 may be integrated in the grid. Each GAS station 706 may be able to supply over 5000 homes with their electricity needs during peak hours. By letting the GAS station network 706 fill all energy banks during off peak hours the current energy infrastructure may be maximized. This new “middleman” may significantly decrease the stress on the grid 704 and may reduce the need to rely on costly and harmful pollution intensive power generators. Local energy banks may also prevent power outages as the energy may be rerouted between GAS stations and vehicles to create new passage ways to avoid downed lines.

The GAS stations' batteries 106 may be charged during off peak hours or from natural renewable sources and disbursed during peak hours. The development of a GAS station infrastructure may create a network of energy storage substations that can handle increased production from solar 418 and wind farms 416 (illustrated in FIG. 4). These substations may be capable of communicating with the governing utility company through wireless or power line communication channels. The substation networks may be fully automatic as energy flow may be controlled from a remote headquarter through the stations control centers 630 (FIG. 6)

Due to the high energy output from Super Juicer 320 (FIG. 3) and the large battery capacity 306 (FIG. 3), the station may be able to increase a vehicle's range by more than 30 miles in matter of minutes. Each stations battery module 604 (FIG. 6) may have an independent SO2 capture system in case of battery failure. Capture system may capture the SO2 gas in a sealed enclosure or an absorbent material. Each one of these modules 604 may be independently connected 612 to the charger for charging or providing energy back to the grid and to ensure that the system may remain redundant in case of individual battery failure.

While the above description and the accompanying figures provide various embodiments, the invention is not limited only to the disclosed embodiments. For example, while most embodiments are described in the context of a vehicle such as a car, the various embodiments of the invention may be implemented in any transportation means or moving object that could benefit from use of rechargeable batteries, such as buses, trains, planes, ships, and motorcycles.

What is claimed is:

1. A system comprising:
a plurality of rechargeable batteries;
a housing in form of a storage facility configured to house the plurality of rechargeable batteries, and
a bi-directional charger coupled to a power grid at one end and coupled to the plurality of rechargeable batteries at another end, and configured to charge the plurality of rechargeable batteries.

2. The system of claim 1, wherein the bi-directional charger is further configured to withdraw charge from the plurality of rechargeable batteries and direct the charge to the power grid.

3. The system of claim 2, wherein the bi-directional charger is configured to be controlled via a remote connection.

4. The system of claim 2, wherein the rechargeable batteries are coupled to the bi-directional charger through a modular connection configured to allow one or more of the rechargeable batteries connect or disconnect from the bi-directional charger while other remaining rechargeable batteries are being charged or when power is being withdrawn from the rechargeable batteries.

5. The system of claim 1, wherein the bi-directional charger is coupled to a plurality of renewable energy sources.

6. The system of claim 5, wherein the bi-directional charger is configured to charge the rechargeable batteries using the combination of any one or combination of the renewable sources and the power grid.

7. The system of claim 6, wherein the bi-directional charger is configured to supply power to the power grid by directing the energy flow from any combination of the renewable energy sources and stored charge in the plurality of rechargeable batteries.

8. The system of claim 1, further comprising:
a charger coupled to the plurality of rechargeable batteries in the storage facility and configured to charge an external rechargeable battery via power from the power grid or the stored charge in the plurality rechargeable batteries.

9. The system of claim 8, wherein the charger is further configured to charge the external rechargeable battery at variable rate.
